(19) United States
(12) Patent Application Publication
(10) Pub. No.: US 2008/0001523 A1
(43) Pub. Date: Jan. 3, 2008

(54) Light emitting diode

(76) Inventor: Steve Hwang, Taipei Hsien (TW)

Correspondence Address: Steve Hwang, 235 Chung - Ho, Box 8-24, Taipei, omitted

(21) Appl. No.: 11/707,240

(22) Filed: Feb. 16, 2007

(30) Foreign Application Priority Data
Jun. 29, 2006 (TW) 095211352

(51) Int. Cl. H05B 33/00

(52) U.S. Cl. 313/498

(57) ABSTRACT

A light emitting diode comprising a plurality of light emitting semiconductor dice; a conductive plate including a positive electrode plate, a negative electrode plate, and a carrier plate. A receiving space is formed between the positive electrode plate, the negative electrode plate and the carrier plate and an upper plate serves for carrying a plurality of light emitting semiconductor dice. The electrodes of the light emitting semiconductor die are at two opposite sides, which includes a positive electrode sheet and a negative electrode sheet. The positive electrode sheet serves for electrically contacting the adjacent positive electrode plate and the negative electrode sheet serves for electrically contacting the adjacent negative electrode sheet. After electric conduction, a light mask serves to package the light emitting semiconductor die.

### FIELD OF THE INVENTION

The present invention relates to light emitting diodes, wherein a light emitting diode has a plurality of light emitting semiconductor dice so as to emit light with required illumination without needing further works. The light emitting diode can be firmly secured to another interface with a high efficiency of heat dissipation.

### BACKGROUND OF THE INVENTION

Referring to FIG. 1, the conventional light emitting diode 1 has only one light emitting semiconductor die 10. The pins of the electrodes of the light emitting semiconductor die 10 are welded to a circuit. A surface of the light emitting semiconductor die 1 is packaged with an insulated light mask 12.

In application, due to the requirement of illumination, the number of light emitting diodes used is more than one, for example, in a light emitting panel, a plurality of light emitting diodes are connected in series or in parallel for providing light, as shown in FIG. 1, the pins 22 of each light emitting diode 1 are inserted into a circuit board 13. A plurality of,light emitting diodes are used to provide sufficient illumination.

However, above mentioned light emitting diodes are easy to lose and the exposed pins are easily destroyed. The pins are formed by punching, polished, electroplated, etc. Not only the resources are wasted, but also the pollution is induced in the manufacturing processes. Moreover, if a plurality of light emitting diodes are necessary, they are inserted into a circuit board one by one.

### SUMMARY OF THE INVENTION

Accordingly, the primary object of the present invention is to provide a light emitting diode, wherein a light emitting diode has a plurality of light emitting semiconductor dice so as to emit light with required illumination without needing further works. The light emitting diode can be firmly secured to another interface with a high efficiency of heat dissipation.

To achieve above objects, the present invention provides a light emitting diode, comprising: a plurality of light emitting semiconductor dice; a conductive plate including a positive electrode plate, a negative electrode plate, and a carrier plate; the carrier plate being an insulated plate and clamped between the positive electrode plate and negative electrode plate with a thickness smaller than that of the positive electrode plate and the negative electrode plate so that a receiving space is formed between the positive electrode plate, the negative electrode plate and the carrier plate and an upper plate serving for carrying a plurality of light emitting semiconductor dice. The electrodes of the light emitting semiconductor die are at two opposite sides, which includes a positive electrode sheet and a negative electrode sheet, the positive electrode sheet serves for being electrically contact to the adjacent positive electrode plate and the negative electrode sheet serves to be electrically in contact to the adjacent negative electrode sheet); and after electric conduction, a light mask serves to package the light emitting semiconductor die.

Thereby the user can determine the number of the light emitting semiconductor dice required based on the light illumination. The structure can be formed one time, and the complicated manufacturing process can be simplified. Since the conductive plate is formed integrally. The light emitting diode of the present invention can provide a steady interface to be connected to an external circuit. Not only it can be retained safely, but also that the integrity of the light emitting diode with a plurality of light sources is helpful to the beautify of the environment. No exposing welding spot is used, even in a decoration wind, it will not destroy of the beauty of the decoration.

The various objects and advantages of the present invention will be more readily understood from the following detailed description when read in conjunction with the appended drawing.

### BRIEF DESCRIPTION OF THE DRAWINGS

FIG. 1 shows the prior art light emitting diode.

FIG. 2 shows the exploded view of the present invention.

FIG. 3 is a lateral view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

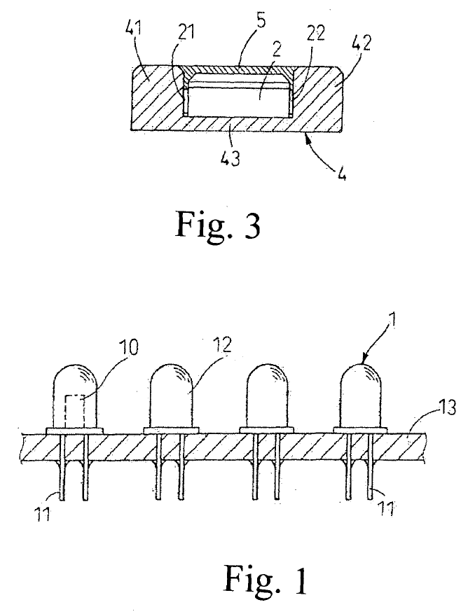

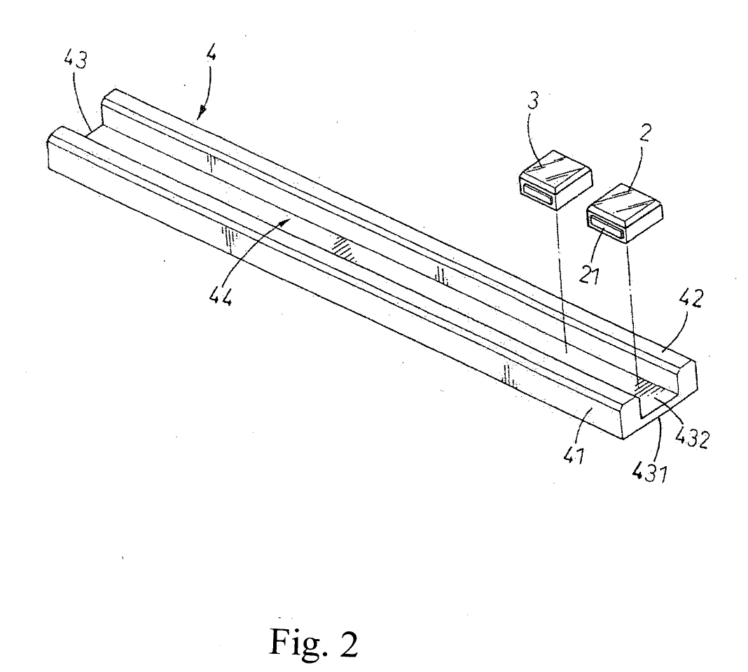

With reference to FIGS. 1 and 2, the light emitting diode of the present invention is illustrated. The present invention has the following elements.

A plurality of light emitting semiconductor dice 2, 3 are included.

A conductive plate 4 includes a positive electrode plate 41, negative electrode plate 42, and a carrier plate 43 which may be formed integrally. The carrier plate 43 is an insulated plate and clamped between the positive electrode plate 41 and negative electrode plate 42 with a thickness smaller than the positive electrode plate 41 and negative electrode plate 42 so that a receiving space 44 is formed between the positive electrode plate 41, negative electrode plate 42 and the carrier plate 43. The bottom surface 431 of the carrier plate 43 is coplanar with one side of the positive electrode plate 41 and one side of the negative electrode plate 42. An upper plate 432 serves to carry a plurality of light emitting semiconductor dice 2, 3.

The electrodes of above mentioned light emitting semiconductor die 2 are at two opposite sides, which includes a positive electrode sheet 21 and a negative electrode sheet 22. The positive electrode sheet 21 serves for electrically contacting to the adjacent positive electrode plate 41 and the negative electrode sheet 22 serves to electrically contacting the adjacent negative electrode sheet 22. After electric conduction, a light mask 5 serves to package the light emitting semiconductor die 2.

Thereby the user can determine the number of the light emitting semiconductor dice 2, 3 required based on the light illumination. The structure can be formed one time, and the complicated manufacturing process can be simplified. Since the conductive plate 4 is formed integrally. The light emitting diode of the present invention can provide a steady interface to be connected to an external circuit. Not only it can be retained safely, but also that the integrity of the light emitting diode with a plurality of light sources is helpful to the beautify of the environment. No exposing welding spot is used, even in a decoration wind, it will not destroy of the beauty of the decoration.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A light emitting diode, comprising:
a plurality of light emitting semiconductor dice (2, 3);
a conductive plate including a positive electrode plate (41), a negative electrode plate (42), and a carrier plate (43); the carrier plate (43) being an insulated plate and clamped between the positive electrode plate (41) and negative electrode plate (42) with a thickness smaller than that of the positive electrode plate (41) and the negative electrode plate (42) so that a receiving space (44) is formed between the positive electrode plate (41), the negative electrode plate (42) and the carrier plate (43) and an upper plate (432) serving for carrying a plurality of light emitting semiconductor dice (2, 3);
wherein the electrodes of the light emitting semiconductor die (2) are at two opposite sides, which includes a positive electrode sheet (21) and a negative electrode sheet (22) the positive electrode sheet (21) serves for electrically contacting the adjacent positive electrode plate (41) and the negative electrode sheet (22) serves for electrically contacting the adjacent negative electrode sheet (22); and after electric conduction, a light mask (5) serves to package the light emitting semiconductor die (2).

2. The light emitting diode as claimed in claim 1, wherein a bottom surface (431) of the carrier plate (43) is coplanar with one side of the positive electrode plate (41) and one side of the negative electrode plate (42).

3. The light emitting diode as claimed in claim 1, wherein the positive electrode plate (41), the negative electrode plate (42), and a carrier plate (43) are formed integrally.
